(19) United States
(12) Patent Application Publication
(10) Pub. No.: US 2006/0251065 A1
(43) Pub. Date: Nov. 9, 2006

(54) Network system having broadcast suppression function

(75) Inventors: Kunihiko Hamamoto, Yokohama (JP); Hiroshi Kinoshita, Yokohama (JP); Atsuko Higashitaniguchi, Yokohama (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/191,005

(22) Filed: Jul. 28, 2005

(30) Foreign Application Priority Data
Mar. 30, 2005 (JP) JP2005-099143

(51) Int. Cl. H04L 12/56

(52) U.S. Cl. 370/389

(57) ABSTRACT

A layer 2 switch includes a first control unit for, when receiving a frame broadcast-transferred in a layer 2 switch located on a transmission source terminal side, if a destination MAC address included in the frame has already been learned and a transmission source MAC address has not been learned, transmitting a virtual response frame supposing a response frame to be originally transmitted from a destination terminal, from a port that has received the frame, and a second control unit for discarding the virtual response frame received from a layer 2 switch located on the destination terminal side.

### BACKGROUND OF THE INVENTION

The present invention relates to a network system for providing a layer 2 (L2) switch service, and more particularly to a network system having a broadcast suppression function.

In the network system for providing the L2 switch service, usually, an L2 switch has a MAC address learning table for storing a transmission source MAC (Media Access Control) address, VLAN ID (Virtual Local Area Network Identifier), and a reception port number, when receiving a frame.

The L2 switch, when relaying the frame, searches this table on the basis of a destination MAC address and the VLAN ID, and if there is no entry, transfers (broadcasts) the frame to all ports to which the VLAN ID belongs, and if there is the entry, transfers (unicasts) the frame only to a corresponding port.

Accordingly, the transferring of the unnecessary frame in the network system is suppressed. Note that, in a course of this transferring process, each entry is removed (aged) from the MAC address learning table, if it is not referred to in a predetermined time. This is referred to as an aging time.

With reference to FIG. 1, a network system SYS for providing the conventional L2 switch service is explained. Here, a case of transmitting a frame from a terminal TEB (MAC address: B) belonging to a user network NW2 of VLAN ID: 1 to a terminal TEA (MAC address: A) belonging to a user network NW1 of the VLAN ID: 1 is exemplified.

At this time, let us suppose that between the terminal TEA and a terminal TEC (MAC address: C) belonging to a user network NW3 of the VLAN ID: 1, the transmission/reception of the frame is already executed, and L2 switches SW1, SW2, and SW3 have already been learned the MAC address: A.

An L2 switch SW5 receiving the frame transmitted from the terminal TEB searches a MAC address learning table TBL in accordance with a destination MAC address: A. However, the MAC address: A is not learned by the L2 switch SW5. Thus, this frame is broadcast-transferred.

The L2 switch SW2 receiving the broadcasted frame searches the MAC address learning table TBL in accordance with the destination MAC address: A. At this time, since the MAC address: A has already been learned, the frame is unicast-transferred to a port 1. Since the L2 switch SW1 has already learned the destination MAC address: A similarly to the L2 switch SW2, the frame is unicast-transferred and transmitted to the terminal TEA.

Since the L2 switch SW4 receiving the broadcasted frame has not learned the MAC address: A, the frame is further broadcast-transferred and transferred to the inside of the user network NW4 of the VLAN ID: 1.

The terminal TEA receiving the frame returns a response frame to the terminal TEB. However, since the L2 switches SW1, SW2 have already learned a MAC address: B, the response frame is unicast-transferred. The L2 switch SW5 that has received this response frame learns the MAC address: A.

Hereafter, the frame of the destination MAC address: A results in the stop of the broadcast-transfer, and it is unicast-transferred to the port 1. However, until receiving the response frame from the terminal TEA, the L2 switch SW5 continues the broadcast transfer. Thus, meanwhile, a bandwidth (transfer bandwidth) is inevitably wastefully exhausted.

If the L2 switch service is widely spread and becomes complex such as a wide area LAN (Local Area Network), the number of the L2 switches constituting the network system is increased, and the influence of the bandwidth consumption caused by the broadcast frame is also increased.

The following are related arts to the present invention.

[Patent document 1]

Japanese Patent Laid-Open Publication No. 2004-193821

[Patent document 2]

Japanese Patent Laid-Open Publication No. 2001-203739

[Patent document 3]

Japanese Patent Laid-Open Publication No. 11-177601

[Patent document 4]

Japanese Patent Laid-Open Publication No. 8-18571

### SUMMARY OF THE INVENTION

It is therefore an object of the present invention to provide a technique that can suppress a wasteful bandwidth consumption caused by broadcast transfer.

In order to solve the foregoing problem, a layer 2 switch of the present invention includes a first control unit for, when receiving a frame broadcast-transferred in a layer 2 switch located on a transmission source terminal side, if a destination MAC address included in the frame has already been learned and a transmission source MAC address has not been learned, transmitting a virtual response frame supposing a response frame to be originally transmitted from a destination terminal, from a port receiving the frame; and a second control unit for discarding the virtual response frame received from a layer 2 switch located on the destination terminal side.

In this configuration, in the virtual response frame, the destination MAC address of the frame is set for the transmission source MAC address, the transmission source MAC address of the frame is set for the destination MAC address, and all “0” data is set for a payload section, respectively.

The layer 2 switch further includes a third control unit for, if the facts that the destination MAC address included in the frame has already been learned and that the transmission source MAC address have not been learned are detected in accordance with a MAC address learning table, requesting the first control unit to transmit the virtual response frame from the port that has received the frame.

The layer 2 switch further includes a fourth control unit for, in order to protect a duplicate transmission of the virtual response frame to the layer 2 switch located on the transmission source terminal side, after the transmission of the virtual response frame from the port that has received the frame, monitoring the reception frame for a predetermined time, and if the virtual response frame where both of the destination MAC address and the transmission source MAC address have already been learned is received from the layer 2 switch located on the destination terminal side, discarding the received virtual response frame.

The layer 2 switch further includes a fifth control unit for determining a transmission necessity or rejection of the virtual response frame, on the basis of an elapsed time of an aging time to delete learning information which is not referred to in the MAC address learning table for a predetermined time.

According to the present invention, the L2 switch, if receiving the frame in which the transmission source MAC address has not been learned and the MAC address has already been learned, instantly returns the virtual response frame pseudo to the response frame from the destination terminal. Accordingly, the L2 switch that does not learn the transmission source MAC address (the destination MAC address of the frame received by the L2 switch) of the virtual response frame can stop the broadcast-transfer before receiving the response frame from the destination terminal. Consequently, it is possible to suppress the wasteful bandwidth consumption caused by the broadcast-transfer.

Also, it is possible to learn only the effective MAC address by selecting the transmission necessity or rejection of the virtual response frame, on the basis of the elapsed time of the aging time.

Other objects, features, and advantages of the present invention will be apparent by reading the following embodiments when considered in connection with the drawings and the accompanying Scope of Claims.

### BRIEF DESCRIPTION OF THE DRAWINGS

FIG. 1 is a view explaining a conventional network system;

FIG. 2 shows a configuration of a network system in an embodiment of the present invention;

FIG. 3 shows a configuration of an L2 switch in the embodiment of the present invention;

FIG. 4 sows a format of a virtual response frame in the embodiment of the present invention;

FIG. 5 is a view explaining a first operation example in the network system shown in FIG. 2;

FIG. 6 is a view explaining the first operation example in the network system shown in FIG. 2;

FIG. 7 is a view explaining a second operation example in the network system shown in FIG. 2;

FIG. 8 is a view explaining a third operation example in the network system shown in FIG. 2; FIG. 9 is a view explaining a first specific example (network configuration example);

FIG. 10 is a view explaining the first specific example (a frame transmission to an L2 switch SW2 from a terminal TEB);

FIG. 11 is a view explaining the first specific example (a virtual response frame transmission from the L2 switch SW2);

FIG. 12 is a view explaining the first specific example (a frame transmission to a terminal TEA from the L2 switch SW2)

FIG. 13 is a view explaining the first specific example (a virtual response frame transmission to the terminal TEB from the L2 switch SW2);

FIG. 14 is a view explaining the first specific example (a MAC address learning table of the L2 switches SW1, SW2 and SW3 after the frame transmission/reception between the terminal TEA and the terminal TEC);

FIG. 15 is a view explaining the first specific example (the MAC address learning table of the L2 switch SW5 before the frame reception from the terminal TEB);

FIG. 16 is a view explaining the first specific example (the MAC address learning table of the L2 switch SW5 after the frame reception from the terminal TEB);

FIG. 17 is a view explaining the first specific example (the MAC address learning table of the L2 switch SW2 after the frame reception from the terminal TEB);

FIG. 18 is a view explaining the first specific example (the MAC address learning table of the L2 switch SW5 after the virtual response frame reception from the L2 switch SW2);

FIG. 19 is a view explaining the first specific example (a virtual response frame monitoring state management table of the L2 switch SW5 at the time of the frame reception from the terminal TEB);

FIG. 20 is a view explaining the first specific example (the virtual response frame monitoring state management table of the L2 switch SW2 at the time of the frame reception from the terminal TEB);

FIG. 21 is a view explaining the first specific example (the virtual response frame monitoring state management table of the L2 switch SW2 after the virtual response frame transmission);

FIG. 22 is a view explaining the first specific example (the virtual response frame monitoring state management table of the L2 switch SW2 after the virtual response frame reception);

FIG. 23 is a view explaining the first specific example (the virtual response frame content transmitted from the L2 switch SW2 (IEEE802.3));

FIG. 24A is a view explaining the first specific example (a process flow 1 of a filtering control section);

FIG. 24B is a view explaining the first specific example (the process flow 1 of a filtering control section);

FIG. 25 is a view explaining the first specific example (a process flow of a learning table control section);

FIG. 26 is a view explaining the first specific example and a second specific example (a process flow of a virtual response frame control section);

FIG. 27 is a view explaining the first specific example and the second specific example (a process flow 2 of the filtering control section);

FIG. 28 is a view explaining the first specific example and the second specific example (a process flow 3 of the filtering control section);

FIG. 29 is a view explaining a second specific example (a network configuration example);

FIG. 30 is a view explaining the second specific example (a frame transmission to the terminal TEA from the terminal TEB);

FIG. 31 is a view explaining the second specific example (the MAC address learning table of the L2 switch SW2 after the frame transmission/reception between the terminal TEA and the terminal TEC);

FIG. 32 is a view explaining the second specific example (the MAC address learning table of the L2 switch SW2 after the frame reception from the terminal TEB);

FIG. 33 is a view explaining the second specific example (the MAC address learning table of the L2 switch SW5 after the frame reception from the terminal TEA);

FIG. 34A is a view explaining the second specific example (a process flow of the learning table control section); and

FIG. 34B is a view explaining the second specific example (a process flow of the learning table control section).

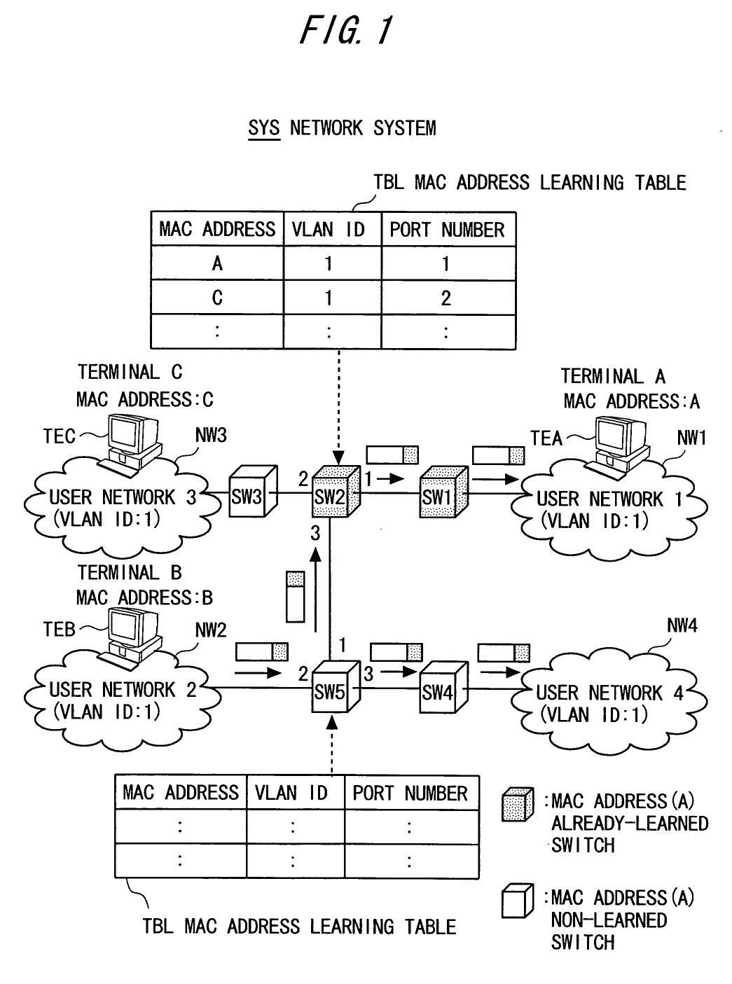

### DETAILED DESCRIPTION OF THE PREFERRED EMBODIMENTS

The present invention will be described below in detail with reference to the attached drawings. Preferred embodiments of the present invention are illustrated on the drawing. However, the present invention can be implemented in many different manners, and should not be construed to be limited to the embodiments described in this specification. Rather, those embodiments are provided such that the disclosure of this specification becomes complete and perfect and the scope of the present invention is sufficiently appreciated by one skilled in the art.

[Basic Function of L2 Switch]

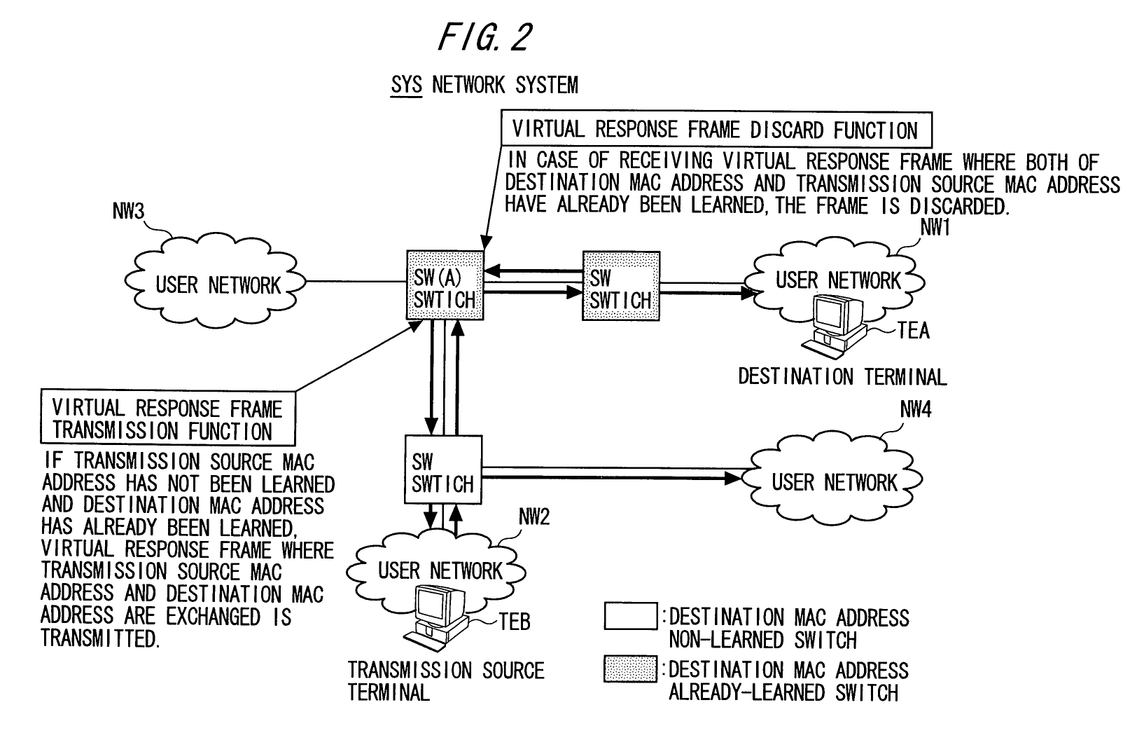

With reference to FIG. 2 showing a network system in an embodiment of the present invention, an L2 switch SW (here, an L2 switch SW(A)) in a network system SYS for providing an L2 switch service has a virtual response frame transmission function for, if, when receiving a frame (strictly, a data frame) through a reception port, a transmission source MAC address of the received frame has not been learned and a destination MAC address has already been learned, transmitting a virtual response frame (VRF) where the transmission source MAC address and the destination MAC address are exchanged from the frame reception port.

Also, the L2 switch SW (A) having transmitted this virtual response frame (the virtual response frame where the transmission source MAC address has not been learned and the destination MAC address has already been learned) further has a virtual response frame discard function for discarding the virtual response frame where both of the destination MAC address and transmission source MAC address which are received from a different L2 switch SW have already been learned.

Accordingly, the L2 switch SW (A) enables the establishment of the network system SYS having a MAC broadcast suppression function for reducing a transfer time of a broadcast frame.

This network system SYS includes user networks NW1, NW2, NW3 and NW4. A destination terminal TEA is accommodated in the user network NW1, and a transmission source terminal TEB is accommodated in the user network NW2.

[Configuration of L2 Switch]

Each L2 switch SW constituting the network system SYS shown in FIG. 2 employs the following configuration, in order to carry out the virtual response frame transmission function, the virtual response frame discard function and the like.

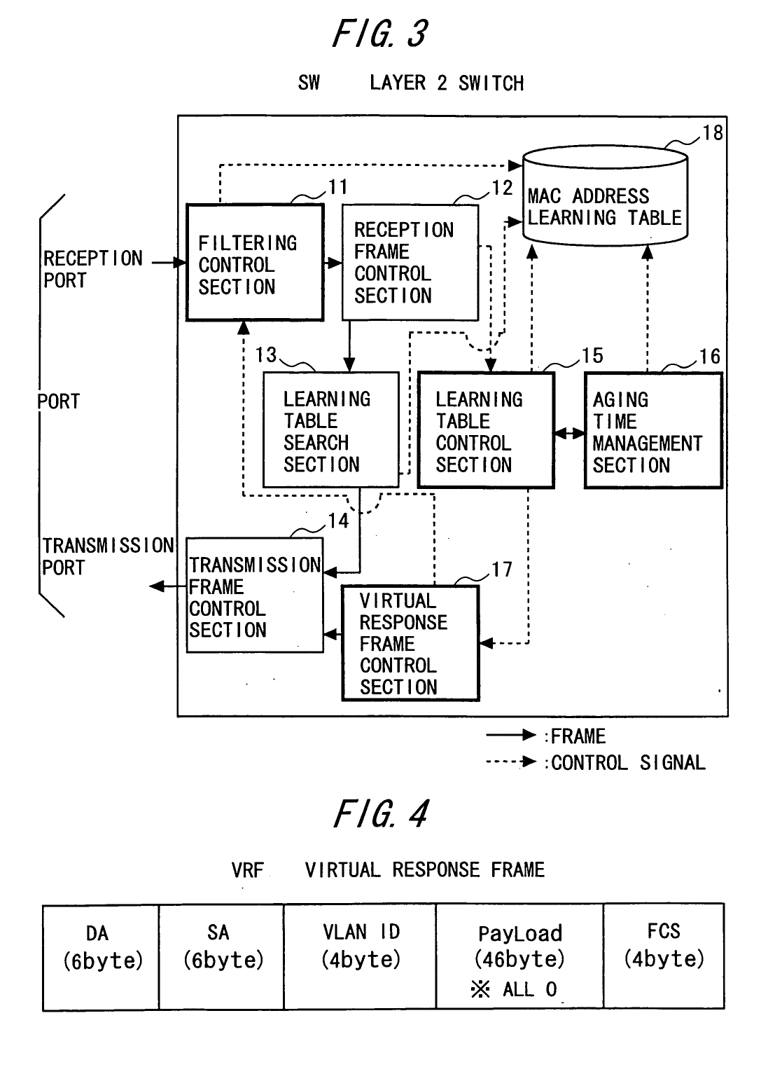

With reference to FIG. 3, a filtering control section 11 constituting the L2 switch SW checks the frame content, and if it agrees with a filtering condition which will be detailed later, discards the frame. The filtering control section 11 manages the monitoring state of the virtual response frame, and monitors the reception frame for a certain time (predetermined time) in the case when the virtual response frame is under monitoring, and discards the virtual response frame of a discard target.

A reception frame control section 12 requests a learning table control section 15 to register the transmission source MAC address of the frame, VLAN ID and a reception port number in a MAC address learning table 18.

A learning table search section 13 searches the MAC address learning table 18 for a port number to transmit the frame, in accordance with the destination MAC address of the frame and the VLAN ID.

A transmission frame control section 14 transfers the frame to a transmission port, in accordance with the search result of the MAC address learning table 18.

The learning table control section 15 registers the transmission source MAC address of the frame, the VLAN ID and the reception port number in the MAC address learning table 18. The learning table control section 15 requests a virtual response frame control section 17 to transmit the virtual response frame, if the transmission source MAC address of the received frame has not been learned and the destination MAC address has already been learned. Also, the learning table control section 15 determines whether or not the transmission of the virtual response frame is necessary, on the basis how much aging time has elapsed.

An aging time management section 16 manages the aging time, with regard to the various learning information of the MAC address learning table 18. Here, the learning information includes the MAC address, VLAN ID and port number, which are registered in the MAC address learning table 18. In the MAC address learning table 18, learning information that has not been referred to for a certain time period is removed. The aging time refers to the certain time period at this time.

The virtual response frame control section 17 generates the virtual response frame (VRF) that is a frame to instruct each L2 switch SW supposing a response frame (RF), which is originally transmitted (replied) from a destination terminal, to learn the destination MAC address.

Specifically, the virtual response frame control section 17 sets the destination MAC address of the received frame for the transmission source MAC address, sets the transmission source MAC address of the received frame for the destination MAC address, and sets the VLAN ID of the received frame for the VLAN ID, and generates the virtual response frame where all 0 (All “0”) is set for a payload section, and requests the transmission frame control section 14 to transmit the virtual response frame from the reception port of the frame.

Also, the virtual response frame control section 17 requests the filtering control section 11 to change the virtual response frame monitor state during the monitoring.

Note that in FIG. 3 showing the configuration of the L2 switch SW, a solid line arrow indicates the propagation direction of the frame, and a dotted line arrow indicates the propagation direction of a control signal.

FIG. 4 shows the schema of the format of the virtual response frame (VRF) generated by the virtual response frame control section 17. In the format of this virtual response frame, DA is a destination MAC address, SA is a transmission source MAC address, and VLAN ID is an identifier to identify VLAN, and a single value is employed in the L2 network (user network). Moreover, in this format, the payload section is the storage section of the data (All “0”) to enable the identification of the virtual response frame, and FCS is a frame check sequence.

[Operation of Network System]

Examples of various operations in the network system SYS according to an embodiment of the present invention shown in FIG. 2 will be described below.

### FIRST OPERATION EXAMPLE

In the case of the frame reception where a destination MAC address (DA:A) has already been learned and a transmission source MAC address (SA:B) has not been learned:

In the network system SYS explained as a first operation example with reference to FIG. 2 to FIG. 6, the prerequisite condition assumed is that between the terminal TEA accommodated in the user network NW1 and the terminal TEC accommodated in the user network NW3, the frame transmission/reception has already been executed and that the L2 switch SW1 and the L2 switch SW2 have already learned the destination MAC address of the terminal TEA.

In this network system SYS, the destination MAC address has not been learned. Thus, the L2 switch (broadcast frame (BCF) transmission switch) SW3 for broadcast-transferring the frame does not receive the response frame (RF), which is usually transmitted from the terminal (destination terminal) TEA corresponding to this destination MAC address, but can receive the virtual response frame (VRF) transmitted from the L2 switch (BCF relay switch) SW2 that has already learned this destination MAC address and learn the destination MAC address.

The filtering control section 11 of the L2 switch (BCF transmission switch) SW3 receiving the frame transmitted from the terminal TEB accommodated in the user network NW2 judges the virtual response frame monitoring state, in accordance with the content of a virtual response frame monitoring state management table (which will be detailed later) held therein, before passing the received frame to the reception frame control section 12, without passing the received frame as it is to the reception frame control section 12, and in the case of during the monitoring stop, passes the received frame to the reception frame control section 12.

The reception frame control section 12 receiving the frame from the filtering control section 11 requests the learning table control section 15 to register the transmission source MAC address (SA:B) of the frame, the VLAN ID and the reception port number in the MAC address learning table 18, and then passes the frame to the learning table search section 13.

The learning table search section 13 receiving the frame from the reception frame control section 12 searches the MAC address learning table 18 in accordance with the destination MAC address (DA:A) of the frame and the VLAN ID. Then, the learning table search section 13 requests the transmission frame control section 14 to broadcast-transfer the frame, because this destination MAC address has not been learned. The transmission frame control section 14 receiving this request broadcasts the frame from the ports 1, 3.

The learning table control section 15 usually searches the MAC address learning table 18 in accordance with the transmission source MAC address (SA:B) of the frame and the VLAN ID. However, since this MAC address has not been learned, it registers this transmission source MAC address: B, the VLAN ID: 1, and the reception port number: 2, in the MAC address learning table 18. However, here, if the transmission source MAC address of the frame has not been learned, the learning table control section 15 registers this transmission source MAC address, VLAN ID and reception port number in the MAC address learning table 18, and then searches the MAC address learning table 18 in accordance with the destination MAC address: A and the VLAN ID: 1. However, if the destination MAC address has not been learned, the process is ended as it is.

The operations of the filtering control section 11 and reception frame control section 12 in the L2 switch SW2, which corresponds to the BCF relay switch and has received the frame from the L2 switch SW3 that is the BCF transmission switch, are omitted, because they are similar to the L2 switch SW3.

In the L2 switch SW2, the learning table search section 13 receiving the frame from the reception frame control section 12 searches the MAC address learning table 18, in accordance with the destination MAC address: A of the frame and the VLAN ID: 1. Here, since this MAC address has already been learned, the learning table search section 13 requests the transmission frame control section 14 to transmit the frame from the port 1. The transmission frame control section 14 receiving this request transmits the frame from the port 1.

The learning table control section 15, which is requested by the reception frame control section 12 to register a transmission source MAC address: B of the frame, the VLAN ID: 1, and a reception port number: 3 in the MAC address learning table 18, usually searches the MAC address learning table 18 in accordance with the transmission source MAC address of the frame and the VLAN ID. However, since this MAC address has not been learned, it registers the transmission source MAC address, the VLAN ID and the reception port number in the MAC address learning table 18.

However, here, the learning table control section 15, if the transmission source MAC address of the frame has not been learned, registers this transmission source MAC address: B, the VLAN ID: 1, and the reception port number: 3 in the MAC address learning table 18, and then searches the MAC address learning table 18 in accordance with the destination MAC address: A and the VLAN ID: 1.

The learning table control section 15, if the destination MAC address has already been learned, requests the virtual response frame control section 17 to transmit the virtual response frame, in which the destination MAC address is the transmission source MAC address: A of the frame, the transmission source MAC address is the destination MAC address: B of the frame, and the VLAN ID is the VLAN ID: 1 of the frame, from the port 3 of the frame.

The virtual response frame control section 17 generates the virtual response frame (VRF), requests the transmission frame control section 14 to transmit it from the port 3, and passes the virtual response frame to the transmission frame control section 14. Also, the virtual response frame control section 17 requests the filtering control section 11 to start monitoring the virtual response frame.

The transmission frame control section 14 receiving the virtual response frame from the virtual response frame control section 17 transmits the virtual response frame from the port 3. Also, the filtering control section 11, which is requested by the virtual response frame control section 17 to start monitoring the virtual response frame, judges the reception frame monitoring state in accordance with the content of the virtual response frame monitoring state management table. In the case of during the monitoring stop, the filtering control section 11 changes the virtual response frame monitoring state during the monitoring and actuates a virtual response frame monitoring timer. Also, in the case of during the monitoring, the filtering control section 11 resets the virtual response frame monitoring timer, and again actuates it.

Accordingly, if the transmission source MAC address: B of the received frame has not been learned and the destination MAC address: A of the received frame has already been learned, the L2 switch SW2 corresponding to the BCF relay switch can transmit the virtual response frame.

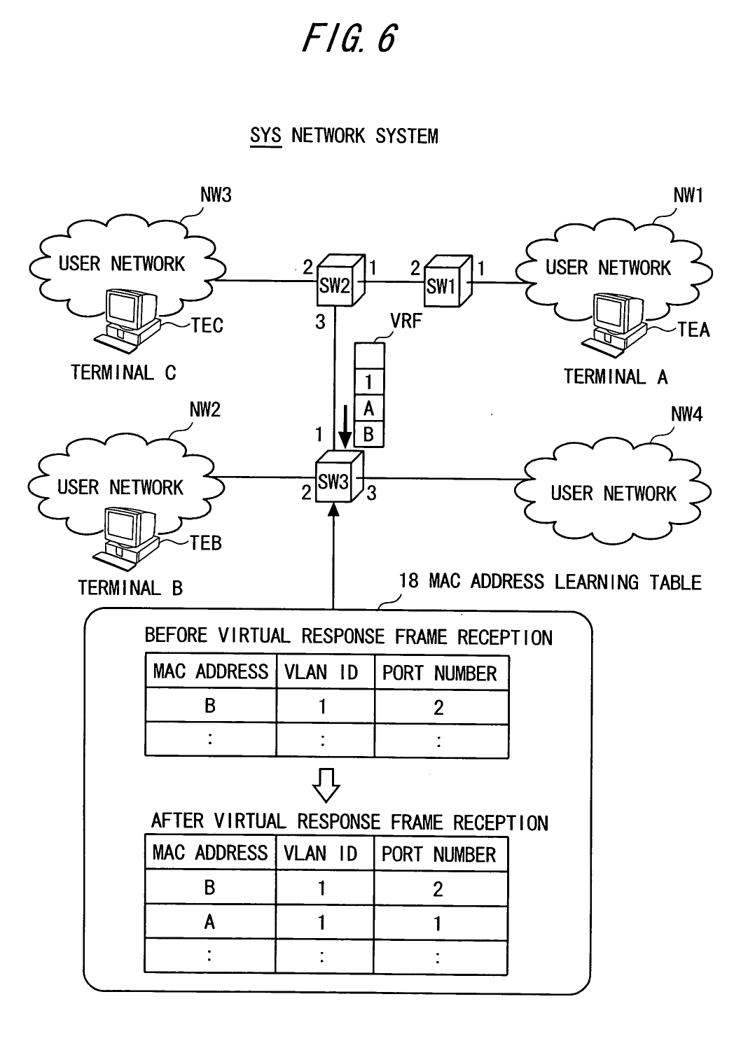

Next, the virtual response frame (VRF) transmitted from the port 3 of the L2 switch SW2 is received by the port 1 of the L2 switch SW3 corresponding to the BCF transmission switch, as shown in FIG. 6. The L2 switch SW3 processes the virtual response frame (VRF) similarly to the usual response frame (RF) and learns the transmission source MAC address (SA:A). After that, if the L2 switch SW3 receives the frame addressed to the terminal TEA from the terminal TEB, this frame is unicast-transmitted from the port 1.

In this way, since the L2 switch SW3 learns the transmission source MAC address (SA:A) of the virtual response frame, the broadcast-transfer can be stopped before the reception of the response frame from the terminal TEA.

### SECOND OPERATION EXAMPLE

In the case of the virtual response frame reception where during the virtual response frame monitoring, the destination MAC address (DA:B) has already been learned and the transmission source MAC address (SA:A) has already been learned:

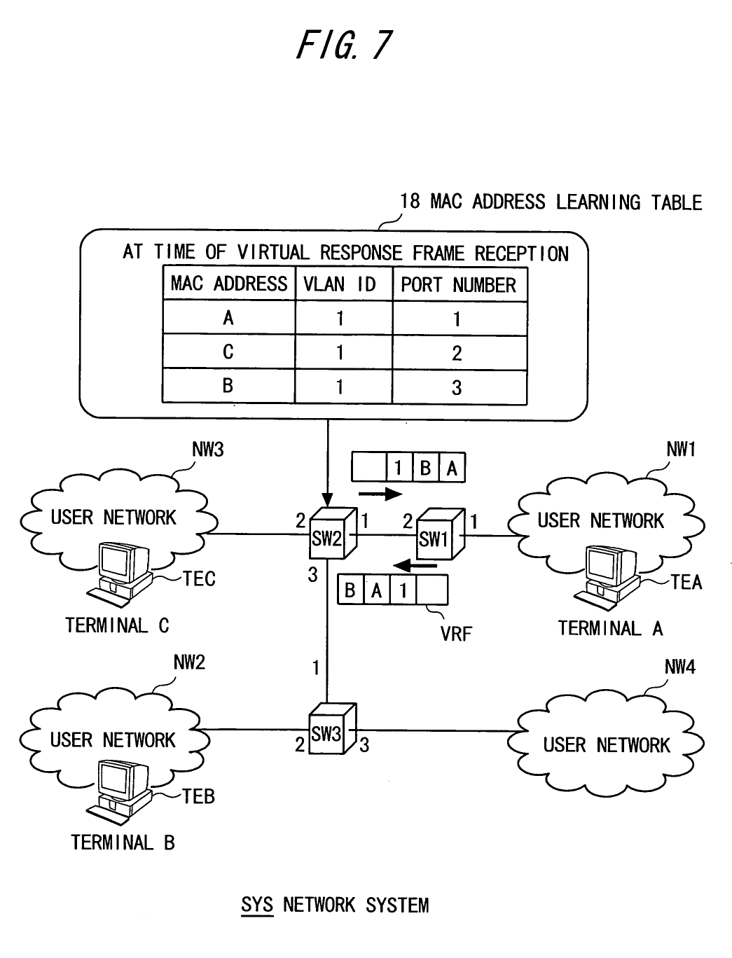

In the network system SYS explained as the second operation example together with reference to FIG. 2, FIG. 3, FIG. 4, and FIG. 7, if the L2 switch SW2 corresponding to the BCF relay switch receives the virtual response frame (VRF) where the destination MAC address and the transmission source MAC address have already been learned, from the L2 switch SW1 corresponding to the destination terminal side switch, during the virtual response frame monitoring, it is possible to discard the received virtual response frame.

This second operation is explained under the assumption that the L2 switch SW1 receives the frame transmitted from the port 1 of the L2 switch SW2 in the first operation example.

In this network system SYS, the L2 switch SW1 corresponding to the destination terminal side switch that has received the frame from the port 1 of the L2 switch SW2 corresponding to the BCF relay switch transmits the virtual response frame (VRF) from the port 2, similarly to the L2 switch SW2 in the first operation example, because the transmission source MAC address (SA:B) of the received frame has not been learned and the destination MAC address (DA:B) has already been learned.

The filtering control section 11 of the L2 switch SW2 that has received the virtual response frame from the L2 switch SW1, prior to passing the received frame (virtual response frame) to the reception frame control section 12, judges the virtual response frame monitoring state in accordance with the virtual response frame monitoring state management table. In the case of during the monitoring, whether or not it is the virtual response frame is judged in accordance with the data of the payload section of the frame.

The filtering control section 11 searches the MAC address learning table 18 in accordance with the transmission source MAC address: A and the VLAN ID: 1, in the case of the virtual response frame (data All “0” of the payload section). Then, the filtering control section 11 further searches the MAC address learning table 18, in accordance with the destination MAC address: B and the VLAN ID: 1, if the transmission source MAC address: A has already been learned.

The filtering control section 11 discards the virtual response frame, if the transmission source MAC address: A and the destination MAC address: B have been already learned. Note that, the filtering control section 11 changes the virtual response frame monitoring state into during the monitoring stop, if the virtual response frame monitoring timer becomes in time-out after that.

In this way, if the L2 switch SW2 corresponding to the BCF relay switch is monitoring the virtual response frame, the transmission source MAC address: A of the virtual response frame received from the L2 switch SW1 corresponding to the destination terminal side switch and the destination MAC address: B are judged to have been already learned, and the frame (virtual response frame) discarded. Thus, it is possible to protect the duplicate transmission of the virtual response frame.

### THIRD OPERATION EXAMPLE

In the case of the frame reception where the destination MAC address has already been learned and the transmission source MAC address (SA:B) has not been learned, after the certain time elapse of the aging time of the already-learned destination MAC address (DA:A):

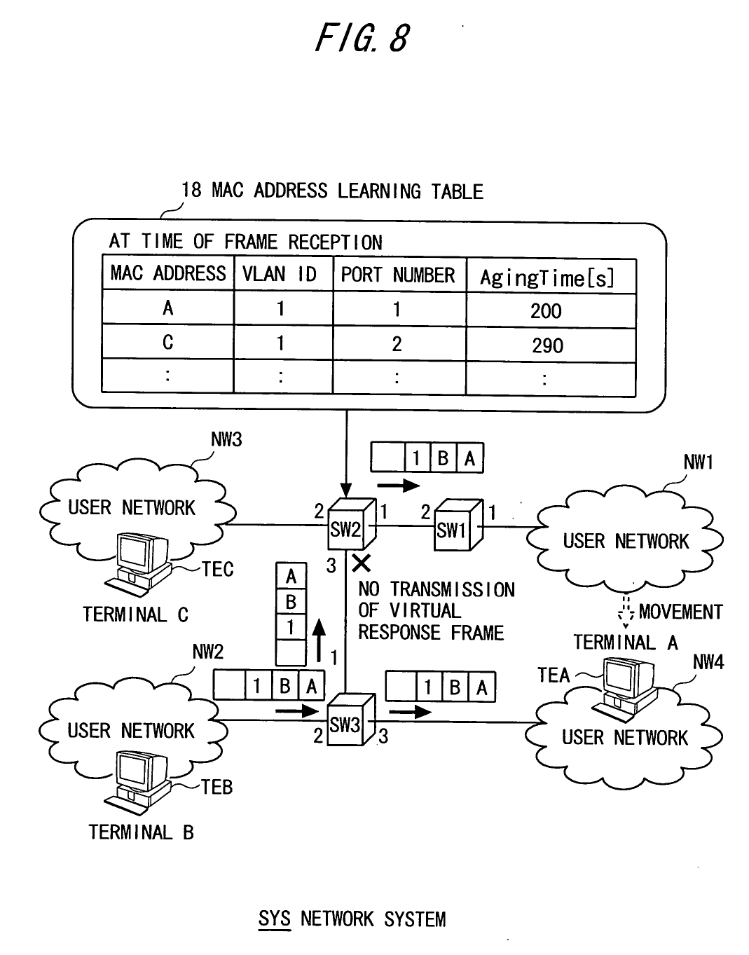

In the network system SYS explained as the third operation example together with reference to FIG. 2, FIG. 3, FIG. 4, and FIG. 8, if the frame where the destination MAC address has already been learned and the transmission source MAC address has not been learned is received, it is possible to determine the transmission necessity or rejection of the virtual response frame (VRF), on the basis of the elapsed time of the aging time of this destination MAC address.

The third operation example employs the premise condition that the terminal TEA accommodated in the user network NW1, which carries out the frame transmission and reception to and from the terminal TEC accommodated in the user network NW3, is in the state after the movement to the user network NW4 that is a different network, and the L2 switch SW1 and the L2 switch SW2 have already learned the MAC address of the terminal TEA in the state prior to the movement.

In the network system SYS, the L2 switch SW3 corresponding to the BCF transmission switch receiving the frame from the terminal TEB accommodated in the user network NW2 broadcast-transfers the frame from the ports 1, 3, similarly to the first operation example.

The operations of the reception frame control section 12 and the filtering control section 11 in the L2 switch SW2 corresponding to the BCF relay switch receiving the frame from the L2 switch SW3 are similar to the first operation example and accordingly omitted.

The learning table search section 13 having received the frame from the reception frame control section 12 requests the transmission frame control section 14 to transmit the frame from the port 1, similarly to the first operation example. Receiving this request, the transmission frame control section 14 transmits the frame from the port 1.

The learning table control section 15, when the reception frame control section 12 requests the learning table control section 15 to register the transmission source MAC address: B of the frame, the VLAN ID: 1, and the reception port number: 3 in the MAC address learning table 18, and the transmission source MAC address of the frame has not been learned, registers the transmission source MAC address, the VLAN ID and the reception port number in the MAC address learning table 18. After that, the learning table control section 15 searches the MAC address learning table 18, in accordance with the destination MAC address: A and the VLAN ID: 1.

Also, the learning table control section 15, when the destination MAC address: A has already been learned, compares the aging time (200 s (Second)) and a virtual response frame transmission judgment value (a value used to judge whether to transmit the virtual response frame or not), and if the aging time is equal to or less than the virtual response frame transmission judgment value, immediately ends the process as it is.

In this way, the L2 switch SW2 corresponding to the BCF relay switch determines whether to transmit the virtual response frame or not on the basis of the elapsed time of the aging time. Thus, it is possible to instruct the L2 switch SW3 corresponding to the BCF transmission switch to carry out the effective MAC address learning.

### FIRST SPECIFIC EXAMPLE

FIG. 9 to FIG. 28 are views explaining the first specific example in the embodiment of the present invention. In this first specific example, the wide area LAN network system is exemplified. However, this can also be applied to the basic L2 network system.

FIG. 9 is the configuration example of the network system SYS in the first specific example. In this network system SYS, VLAN ID: 1 is assigned to all of the respective user networks (1 to 4) NW1, NW2, NW3 and NW4.

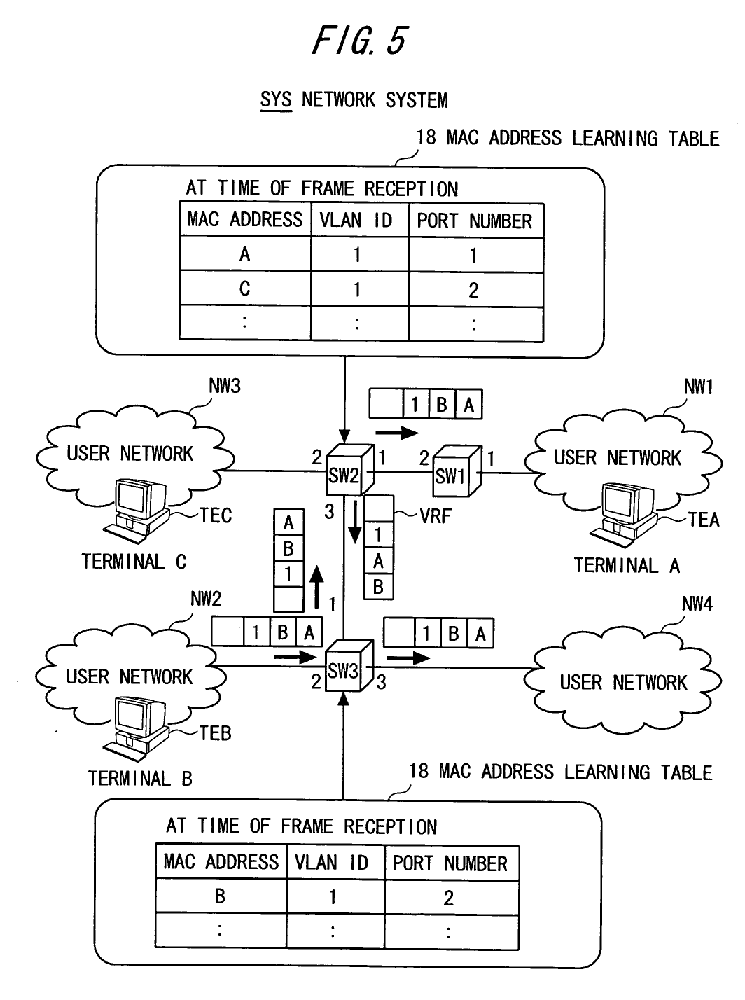

As compared with the first and second operation examples described above with reference to FIG. 5 to FIG. 8, the arrangement of the L2 switches SW1, SW2, SW3, SW4 and SW5 is different. Each of the L2 switches SW1, SW2, SW3, SW4 and SW5 employs the configuration shown in FIG. 3.

The aging time set for each of the L2 switches SW1, SW2, SW3, SW4 and SW5 can be arbitrarily set by a command input from a network management terminal (a personal computer or the like) (not shown), and the like. Here, it is assumed to be set to 300 s in an initial setting.

This first specific example is explained about the case where the frame transmission/reception has already been executed between the terminal TEA accommodated in the user network NW1 and the terminal TEC accommodated in the user network NW3, and the frame is to be transmitted from the terminal TEB accommodated in the user network NW2 to the terminal TEA.

A MAC address of the terminal TEA is 00-E0-00-00-10-10, a MAC address of the terminal TEB is 00-E0-00-00-10-20, and a MAC address of the terminal TEC is 00-E0-00-00-10-30. The VLAN ID: 1 is registered in the port 1, port 2 and port 3 of the respective L2 switches SW1, SW2 and SW3. The terminals TEA, TEB and TEC can be constituted by a personal computer and the like.

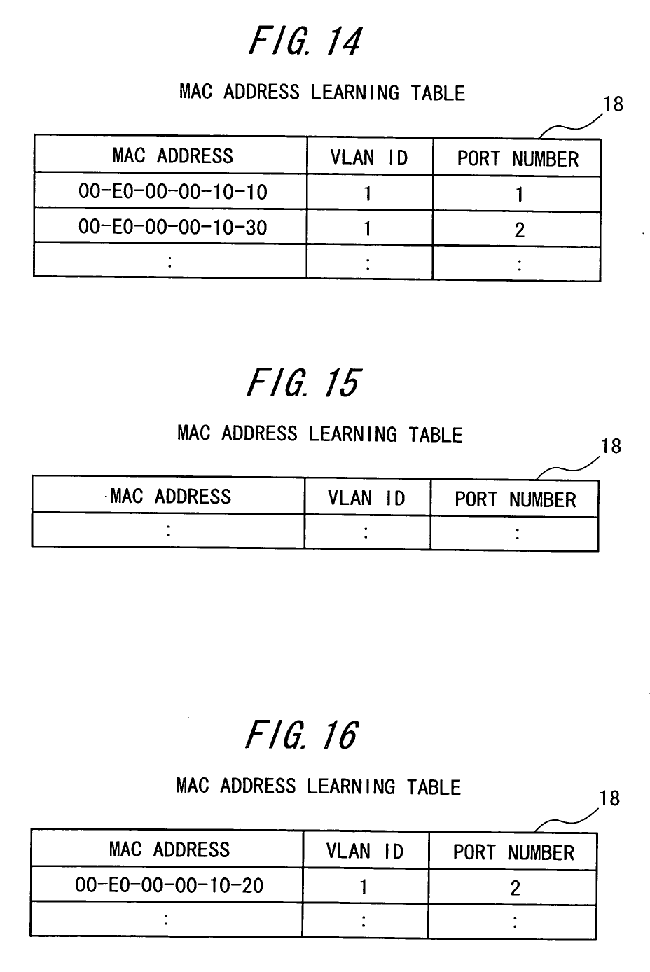

When the frame transmission/reception is carried out between the terminal TEA and the terminal TEC, the MAC address is learned by the L2 switches SW1, SW2 and SW3 by using a known technique. At this time, the MAC address learning table 18 of the L2 switches SW1, SW2 and SW3 is as shown in FIG. 14.

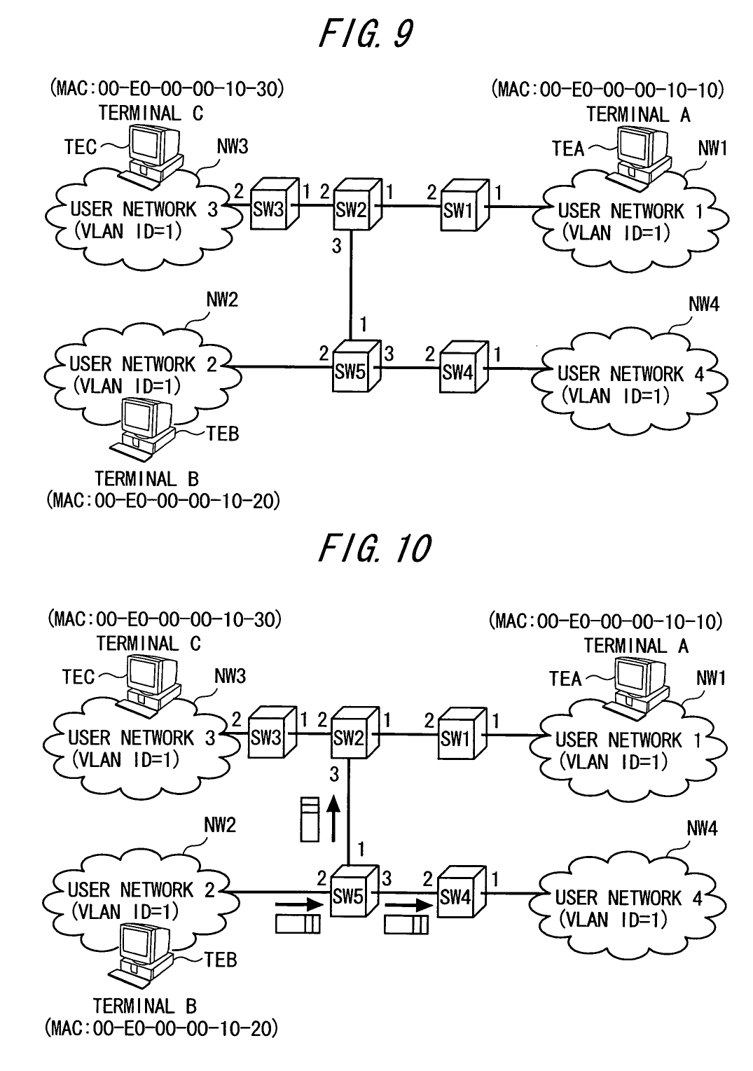

The operation of each L2 switch until the frame transmitted to the terminal TEA of the user network NW1 from the terminal TEB of the user network NW2 is received by the L2 switch SW2 corresponding to the BCF relay switch, as shown in FIG. 10, with the items as the premise condition, is explained.

The VLAN ID: 1 is registered in the port 1, port 2 and port 3 of the L2 switch SW5, and the VLAN ID: 1 is similarly registered in the port 1 and port 2 of the L2 switch SW4. The MAC address learning table 18 of the L2 switches SW1, SW2 and SW3 is in the state as shown in FIG. 14.

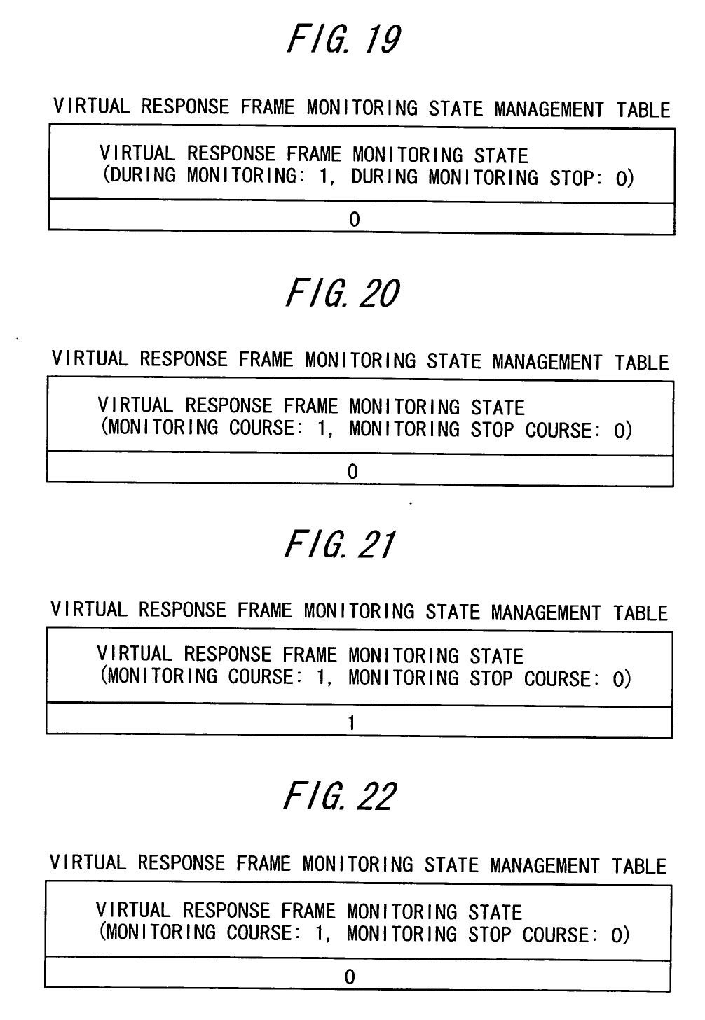

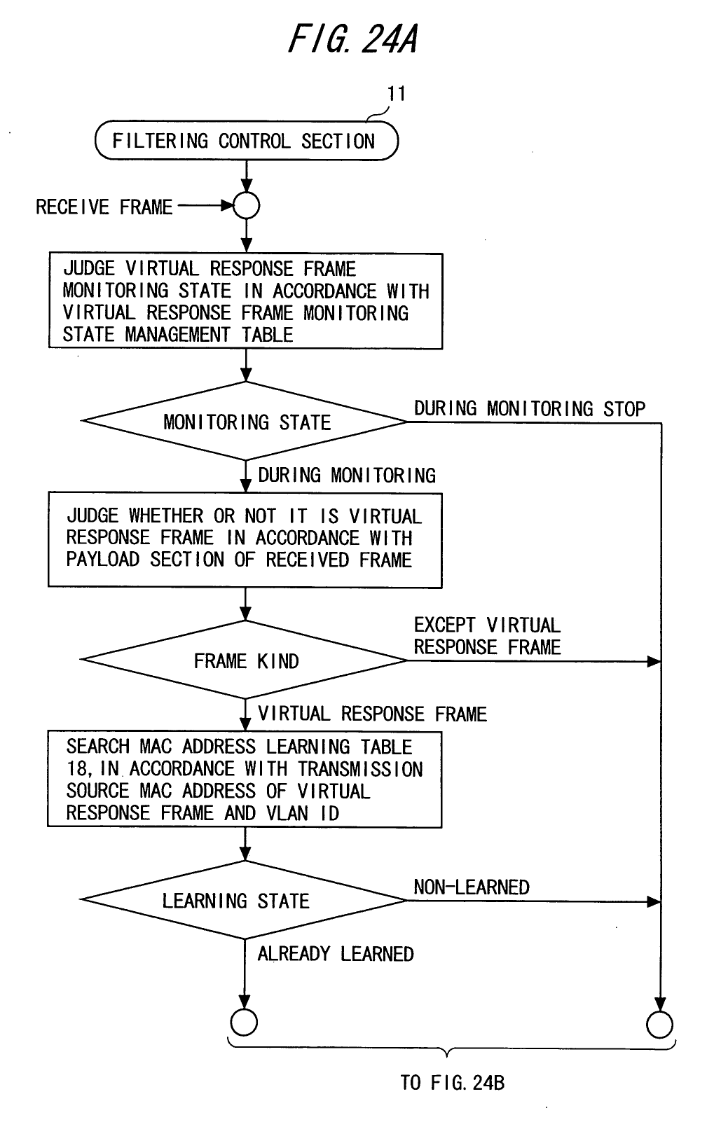

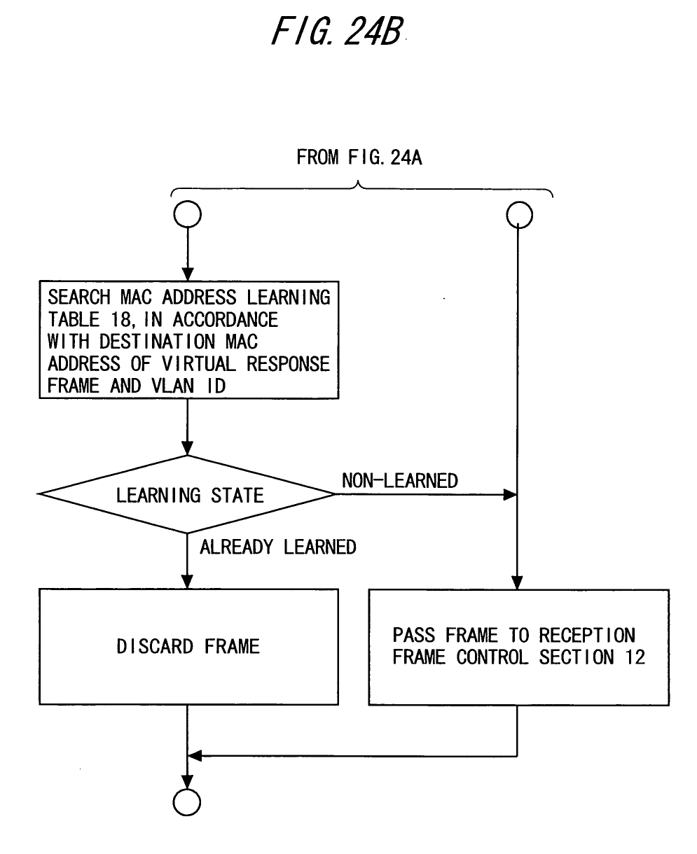

The frame transmitted from the terminal TEB is received by the port 2 of the L2 switch SW5 and passed to the filtering control section 11. The filtering control section 11 judges the virtual response frame monitoring state in accordance with the content of the virtual response frame monitoring state management table held therein, as indicated in process flows of FIG. 24A and FIG. 24B. The filtering control section 11 passes the frame to the reception frame control section 12, because the content of the virtual response frame monitoring state management table is a monitoring stop course: 0, as shown in FIG. 19.

The reception frame control section 12 requests the learning table control section 15 to register the frame transmission source MAC address: 00-E0-00-00-10-20, the VLAN ID: 1, and the reception port number: 2, in the MAC address learning table 18, and passes the frame to the learning table search section 13.

The learning table search section 13 searches the MAC address learning table 18 shown in FIG. 15, in accordance with the frame destination MAC address: 00-E0-00-00-10-10 and the VLAN ID: 1. With a result that the destination MAC address has not been learned, the learning table search section 13 requests the transmission frame control section 14 to broadcast-transfer the frame, and passes the frame.

The transmission frame control section 14, to which the learning table search section 13 passed the frame, transmits (broadcast-transfers) the frame from the port 1 and the port 2.

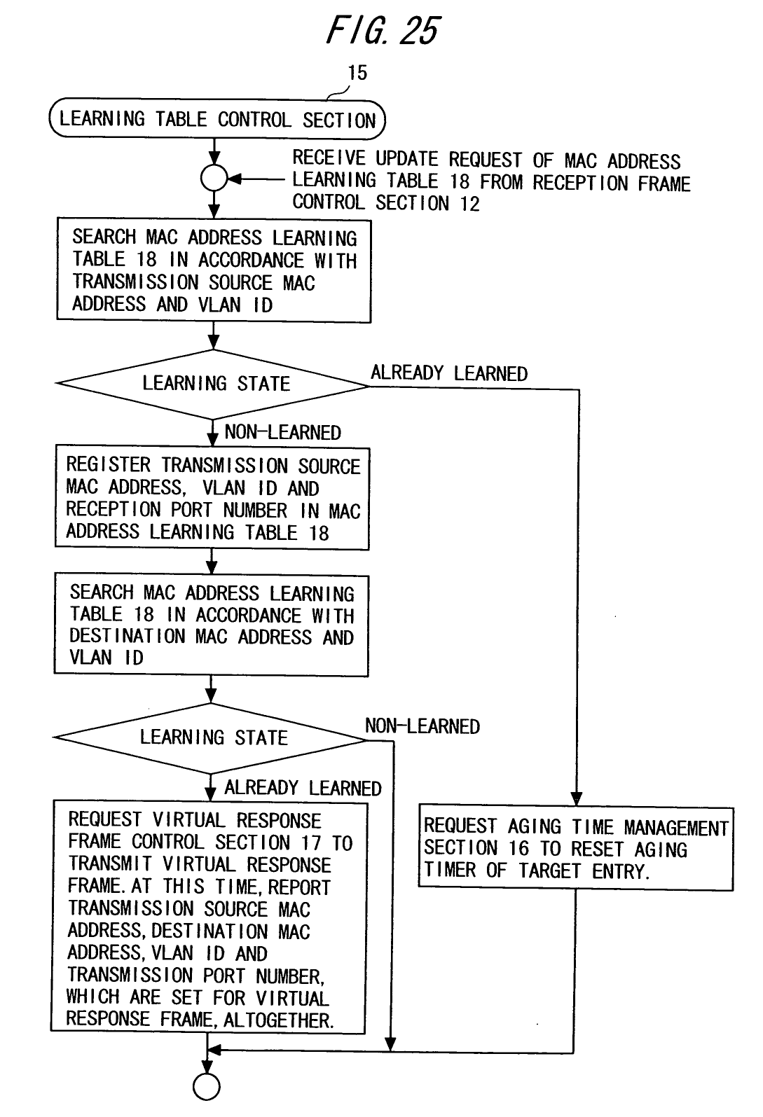

The learning table control section 15, which is requested by the reception frame control section 12 to register the frame transmission source MAC address: 00-E0-00-00-10-20, the VLAN ID: 1, and the reception port number: 2 in the MAC address learning table 18, searches the MAC address learning table 18 shown in FIG. 15, in accordance with the transmission source MAC address: 00-E0-00-00-10-20 and the VLAN ID: 1, as indicated in the process flow of FIG. 25.

The learning table control section 15, since this transmission source MAC address has not been learned, registers the transmission source MAC address: 00-E0-00-00-10-20, the VLAN ID: 1, and the port number: 2, in the MAC address learning table 18. The state of the MAC address learning table 18 at this time is shown in FIG. 16.

Next, the learning table control section 15 searches the MAC address learning table 18 shown in FIG. 16, in accordance with the destination MAC address: 00-E0-00-00-10-10 and the VLAN ID: 1. With a result that the destination MAC address has not been learned, the learning table control section 15 ends the process.

The frame transmitted from the port 1 of the L2 switch SW5 corresponding to the BCF transmission switch is received by the port 3 of the L2 switch SW2 corresponding to the BCF relay switch and passed to the filtering control section 11. The filtering control section 11 judges the virtual response frame monitoring state in accordance with the content of the virtual response frame monitoring state management table, as indicated in process flows of FIG. 24A and FIG. 24B. The filtering control section 11 passes the frame to the reception frame control section 12, because, at this time, the L2 switch SW5 is a monitoring stop course as shown in FIG. 19.

The reception frame control section 12 requests the learning table control section 15 to register the frame transmission source MAC address: 00-E0-00-00-10-20, the VLAN ID: 1, and the reception port number: 3, in the MAC address learning table 18, and passes the frame to the learning table search section 13.

The learning table search section 13 searches the MAC address learning table 18 shown in FIG. 14, in accordance with the frame destination MAC address: 00-E0-00-00-10-10 and the VLAN ID: 1. With a result that the destination MAC address has not been learned, the learning table search section 13 requests the transmission frame control section 14 to transmit the frame from the port 1, and passes the frame.

The transmission frame control section 14 that is requested by the learning table search section 13 to transmit the frame, transmits the frame from the port 1.

The learning table control section 15, which is requested by the reception frame control section 12 to register the frame transmission source MAC address: 00-E0-00-00-10-20, the VLAN ID: 1, and the reception port number: 3, in the MAC address learning table 18, searches the MAC address learning table 18 shown in FIG. 15, in accordance with the transmission source MAC address: 00-E0-00-00-10-20 and the VLAN ID: 1, as indicated in the process flow of FIG. 25.

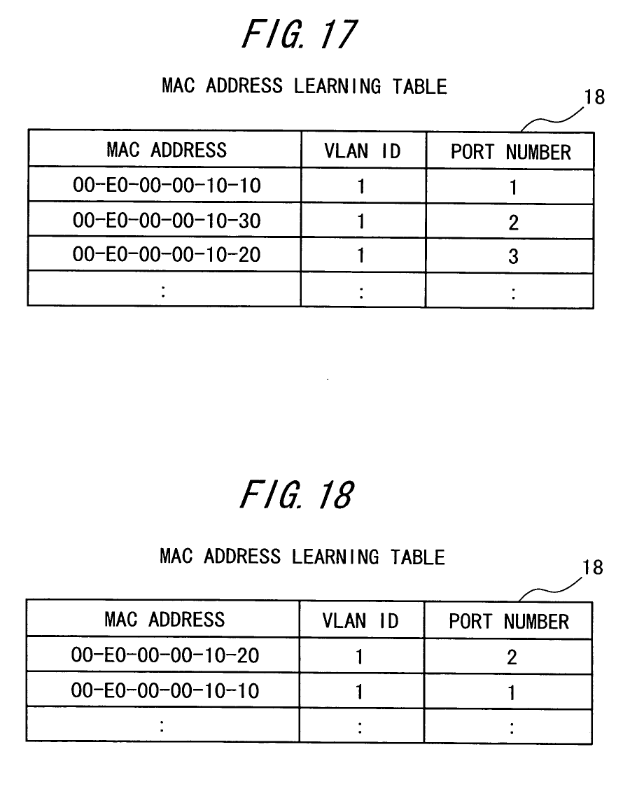

The learning table control section 15, since this transmission source MAC address has not been learned, registers the transmission source MAC address: 00-E0-00-00-10-20, the VLAN ID: 1, and the port number: 3 in the MAC address learning table 18. The state of the MAC address learning table 18 at this time is shown in FIG. 17.

Next, the learning table control section 15 searches the MAC address learning table 18 shown in FIG. 17 in accordance with the destination MAC address: 00-E0-00-00-10-20 and the VLAN ID: 1. The learning table control section 15 requests the virtual response frame control section 17 to transmit the virtual response frame (VRF) of the destination MAC address: 00-E0-00-00-10-20, transmission source MAC address: 00-E0-00-00-10-10 and VLAN ID: 1, from the port 3, because this destination MAC address has already been learned.

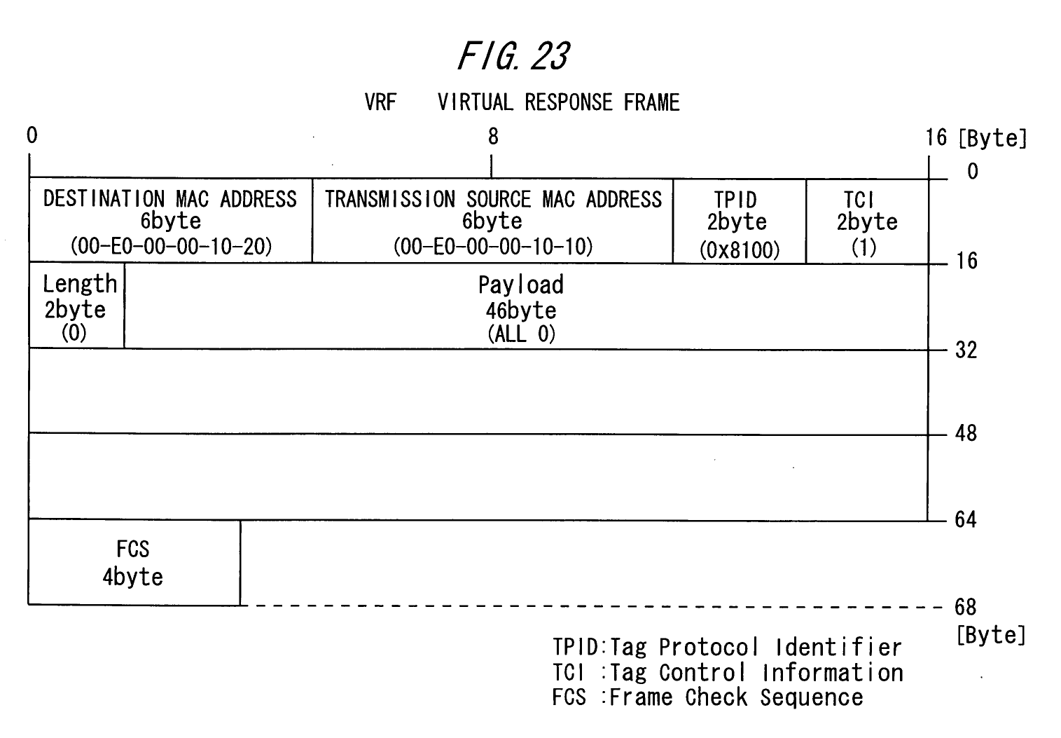

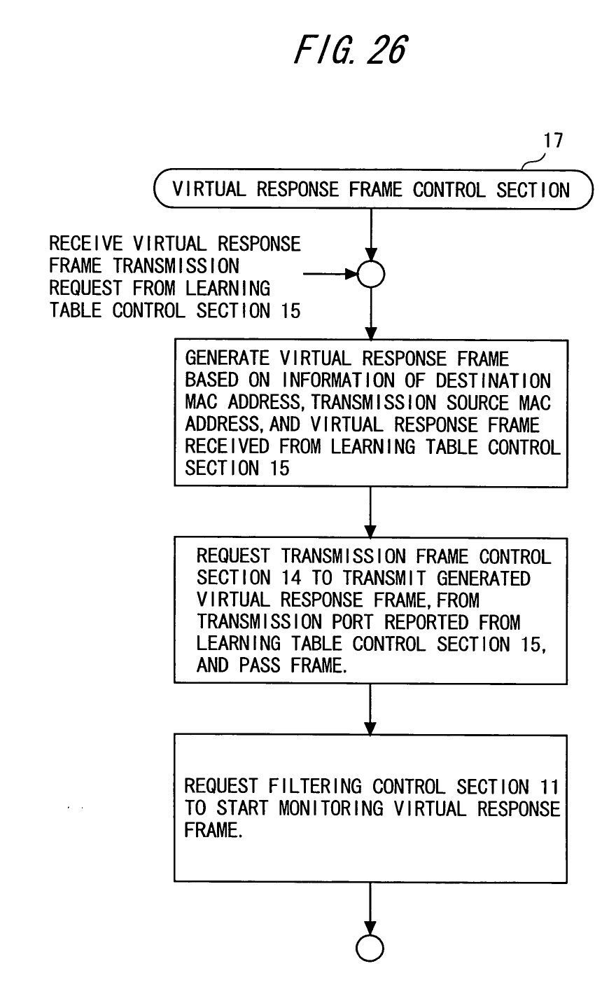

The virtual response frame control section 17 generates the virtual response frame (VRF) shown in FIG. 23, as illustrated in the process flow of FIG. 26, and requests the transmission frame control section 14 to transmit the virtual response frame from the port 3, and passes the virtual response frame. In the virtual response frame (VRF) shown in FIG. 23, TPID (Tag Protocol Identifier) and TCI (Tag Control Information) corresponds to a region to specify the VLAN ID. After that, the virtual response frame control section 17 requests the filtering control section 11 to start monitoring the virtual response frame.

The transmission frame control section 14 that has received the virtual response frame transmission request from the virtual response frame control section 17 transmits the virtual response frame from the port 3, as shown in FIG. 11.

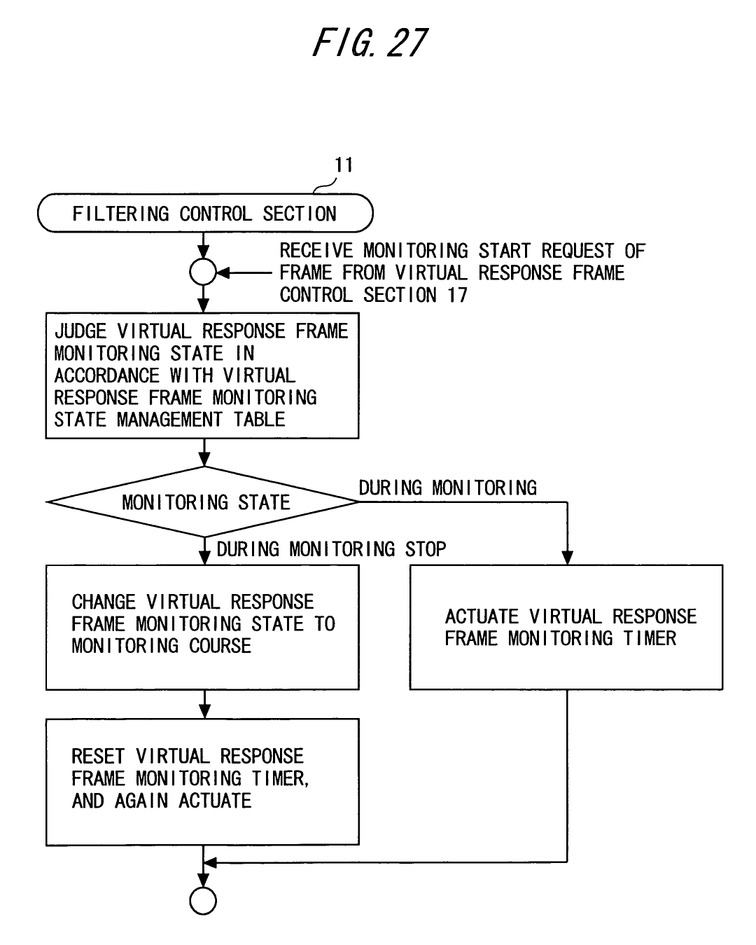

The filtering control section 11, which is requested by the virtual response frame control section 17 to start monitoring the virtual response frame determines the virtual response frame monitoring state in accordance with the virtual response frame monitoring state management table, as illustrated in the process flow of FIG. 27. As shown in FIG. 20, since the L2 switch SW2 is during the monitoring stop, as shown in FIG. 21, the filtering control section 11 changes the virtual response frame monitoring state to the monitoring course: 1, and actuates the virtual response frame monitoring timer.

As mentioned above, in the L2 switch SW2 corresponding to the BCF relay switch, upon reception of the frame where the transmission source MAC address has not been learned and the destination MAC address has already been learned, it becomes possible to transmit the virtual response frame.

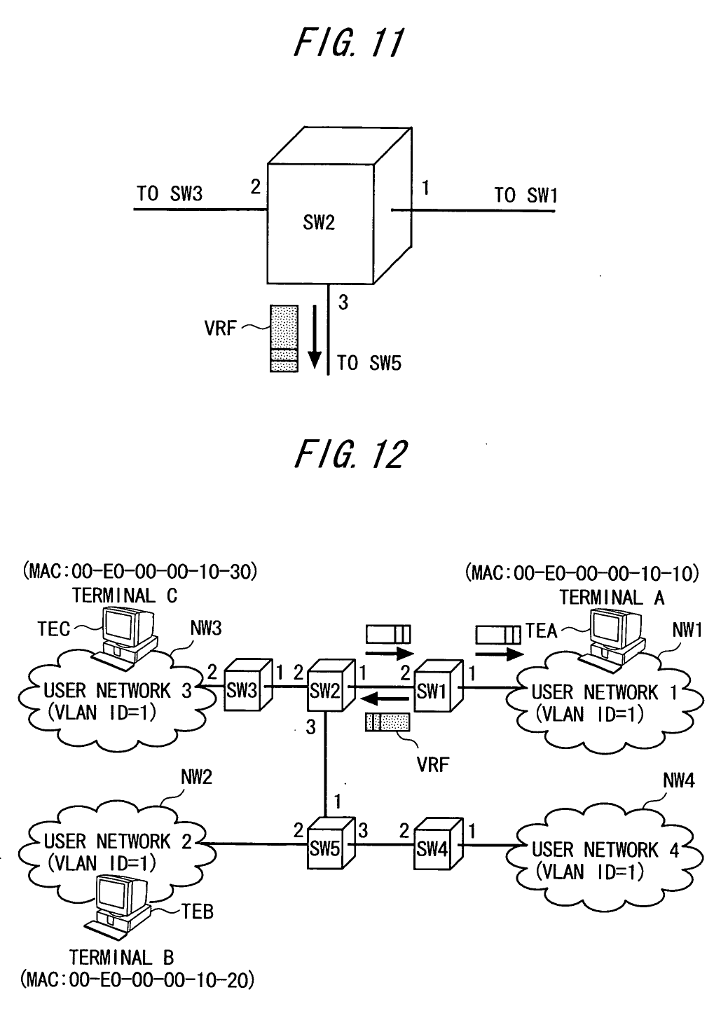

The operation of each L2 switch until the frame transmitted from the port 1 of the L2 switch SW2 shown in FIG. 12 is received by the terminal TEA will be described below.

The frame transmitted from the port 1 of the L2 switch SW2 is received by the port 2 of the L2 switch SW1 corresponding to the destination terminal side switch. Since the MAC address learning table 18 of the L2 switch SW1 is as shown in FIG. 14, the received frame is transmitted from the port 1, and then transmitted to the terminal TEA. Also, the virtual response frame is transmitted from the port 2. The operation of the L2 switch SW1 at this time is similar to the operation of the L2 switch SW2 explained with reference to FIG. 11. Thus, the detailed explanation is omitted.

The virtual response frame transmitted from the port 2 of the L2 switch SW1 is received by the port 1 of the L2 switch SW2 and passed to the filtering control section 11. The filtering control section 11 determines the virtual response frame monitoring state in accordance with the virtual response frame monitoring state management table, as illustrated in the process flows of FIG. 24A and FIG. 24B.

The filtering control section 11 judges whether or not it is the virtual response frame in accordance with the data of the payload section of the frame, because the virtual response frame is in the monitoring course: 1, as shown in FIG. 21. Specifically, the filtering control section 11 determines the frame as the virtual response frame if a payload length is 46 bytes and the data is All “0”.

The filtering control section 11, since the received frame is the virtual response frame, searches the MAC address learning table 18 shown in FIG. 17 in accordance with the transmission source MAC address: 00-E0-00-00-10-10 of the virtual response frame and the VLAN ID: 1.

The filtering control section 11, since this MAC address has already been learned, then searches the MAC address learning table 18 shown in FIG. 17 in accordance with the destination MAC address: 00-E0-00-00-10-20 and the VLAN ID: 1. The filtering control section 11 discards the virtual response frame because this MAC address has already been learned.

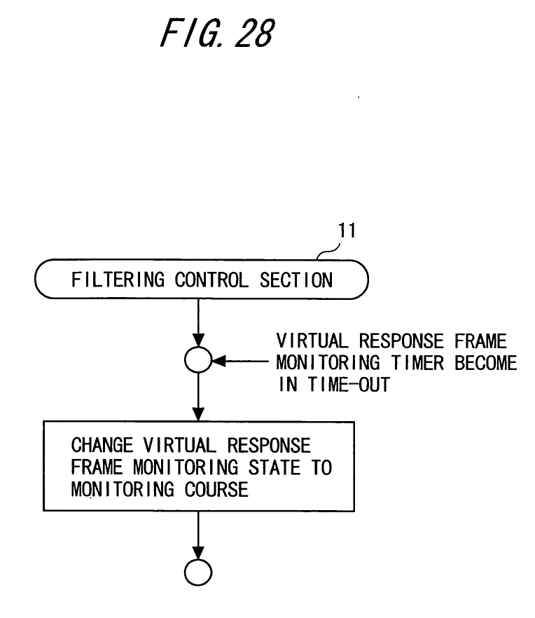

Note that following this, upon time-out of the virtual response frame monitoring timer, as illustrated in the process flow of FIG. 28, the filtering control section 11 changes the virtual response frame monitoring state to the monitoring stop course as shown in FIG. 22.

As described above, the L2 switch SW2 corresponding to the BCF relay switch can discard the frame, if the L2 switch SW2 received the virtual response frame where both of the destination MAC address and the transmission source MAC address have already been learned.

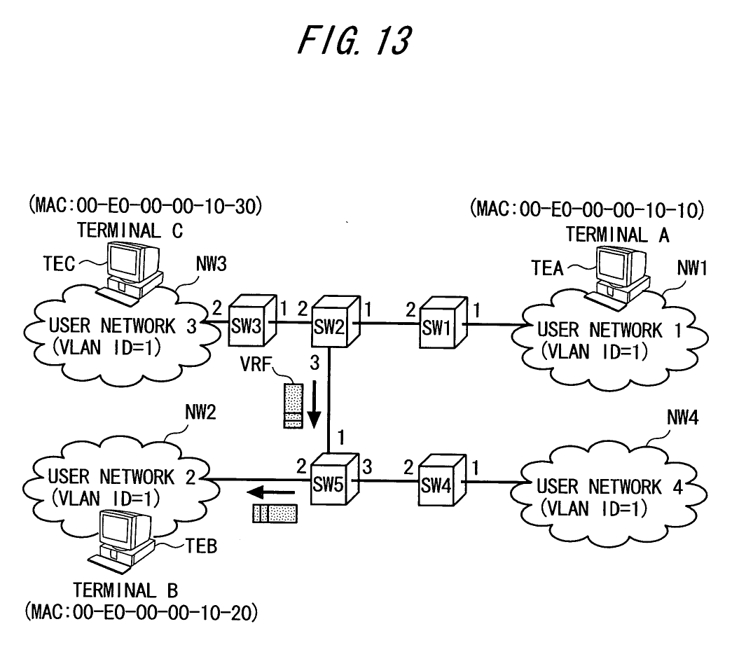

The operation of each L2 switch until the virtual response frame transmitted from the port 3 of the L2 switch SW2 shown in FIG. 13 is received by the terminal TEB will be described below.

The L2 switch SW5 that has received the virtual response frame transmitted from the port 3 of the L2 switch SW2 recognizes the virtual response frame as the usual frame and processes the virtual response frame as the usual frame, searches the MAC address learning table 18 shown in FIG. 18 in accordance with the destination MAC address: 00-E0-00-00-10-20 and the VLAN ID: 1, and transmits the frame from the port 2.

Moreover, the L2 switch SW5 registers the transmission source MAC address: 00-E0-00-00-10-10 of the virtual response frame, the VLAN ID: 1 and the port number: 1 in the MAC address learning table 18.

Hereafter, the frame transmitted to the terminal TEA from the terminal TEB is unicast-transferred from the port 1 to the MAC address learning table 18 of the L2 switch SW5, because the destination MAC address: 00-E0-00-00-10-10 has already been learned.

Note that, the virtual response frame transmitted from the port 2 of the L2 switch SW5 is finally discarded as an unknown frame in the terminal TEB. Since this is also similar to the prior art, the detailed explanation is omitted.

As described above, the L2 switch SW5 corresponding to the BCF transmission switch receives the virtual response frame (VRF). Thus, prior to receiving the response frame (RF) from the terminal TEA, it can learn the transmission source MAC address: 00-E0-00-00-10-10 of the virtual response frame. Therefore, the broadcast-transfer of the frame transmitted to the terminal TEA from the terminal TEB can be quickly converged.

### SECOND SPECIFIC EXAMPLE

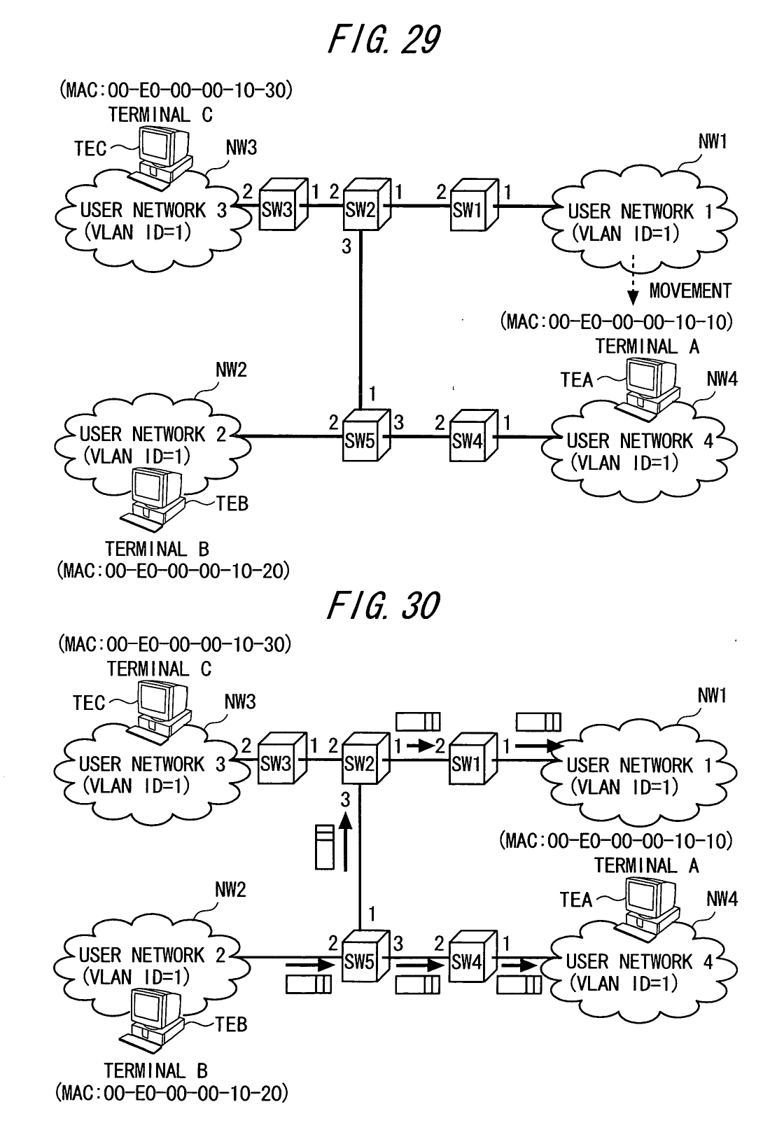

FIG. 29 to FIG. 34A and FIG. 34B are views explaining the second specific example in the embodiment of the present invention. In this second specific example, similarly to the first specific example, the wide area LAN network system is exemplified. However, this can be also applied to the basic L2 network system.

FIG. 29 is the configuration example of the network system SYS in the second specific example. In this network system SYS, the VLAN ID: 1 is assigned to all of the respective user networks NW1, NW2, NW3 and NW4.

As compared with the first and second operation examples described above with reference to FIG. 5 to FIG. 8, the arrangement of the L2 switches SW1, SW2, SW3, SW4 and SW5 is different. Each of the L2 switches SW1, SW2, SW3, SW4 and SW5 employs the configuration shown in FIG. 3.

The aging time set for each of the L2 switches SW1, SW2, SW3, SW4 and SW5 can be arbitrarily set by the command input from the network management terminal (the personal computer or the like) (not shown), and the like. Here, it is assumed to be set to 300 s in the initial setting.

Also, the virtual response frame transmission judgment value set for each of the L2 switches SW1, SW2, SW3, SW4 and SW5 can be arbitrarily set by the command input from the network management terminal, and the like. Here, it is assumed to be set to 240 s in the initial setting.

This second specific example is explained about the case where the frame transmission/reception is already being executed between the terminal TEA accommodated in the user network NW1 and the terminal TEC accommodated in the user network NW3, and the terminal TEA moves from the user network NW1 to the user network NW4, and the frame is then transmitted from the terminal TEB accommodated in the user network NW2 to the terminal TEA.

The MAC address of the terminal TEA is 00-E0-00-00-10-10, the MAC address of the terminal TEB is 00-E0-00-00-10-20, and the MAC address of the terminal TEC is 00-E0-00-00-10-30. The VLAN ID: 1 is registered in the port 1, port 2 and port 3 of the respective L2 switches SW1, SW2 and SW3.

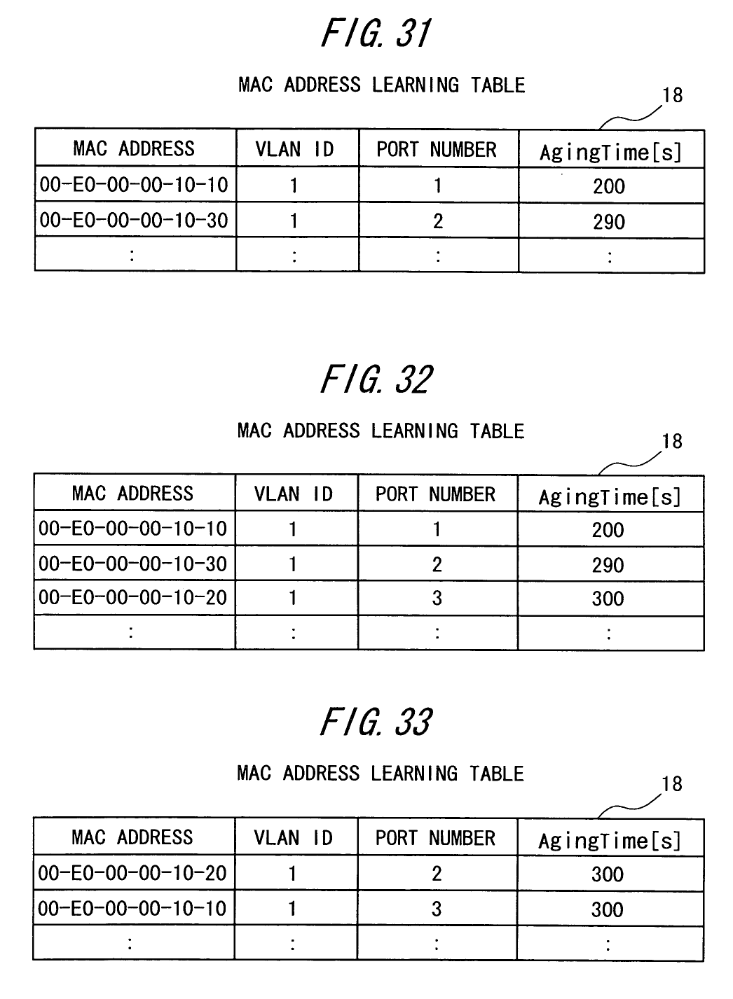

When the frame transmission/reception is carried out between the terminal TEA and the terminal TEC, the MAC address is learned by the L2 switches SW1, SW2 and SW3 by using the known technique. At this time, the MAC address learning table 18 of the L2 switches SW1, SW2 and SW3 is as shown in FIG. 31.

With the items as the premise condition, the operation until the L2 switch SW5 that has received the frame from the terminal TEB of the user network NW2 broadcast-transfers the frame from the port 1 and the port 2 is similar to the first specific example. Thus, the explanation in this second specific example is omitted.

The frame transmitted from the port 1 of the L2 switch SW5 is received by the port 3 of the L2 switch SW2. As for the operations of the L2 switch SW2 after the frame reception, the operations except that of the learning table control section 15 are similar to those of the first specific example. Thus, the explanation of those in this second specific example is omitted.

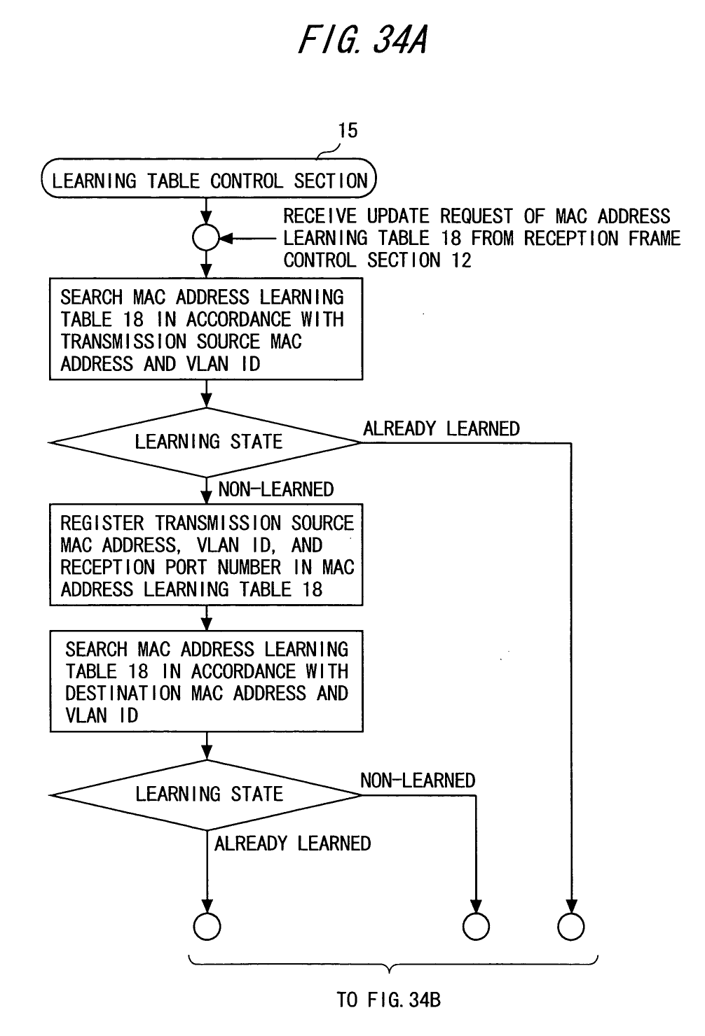

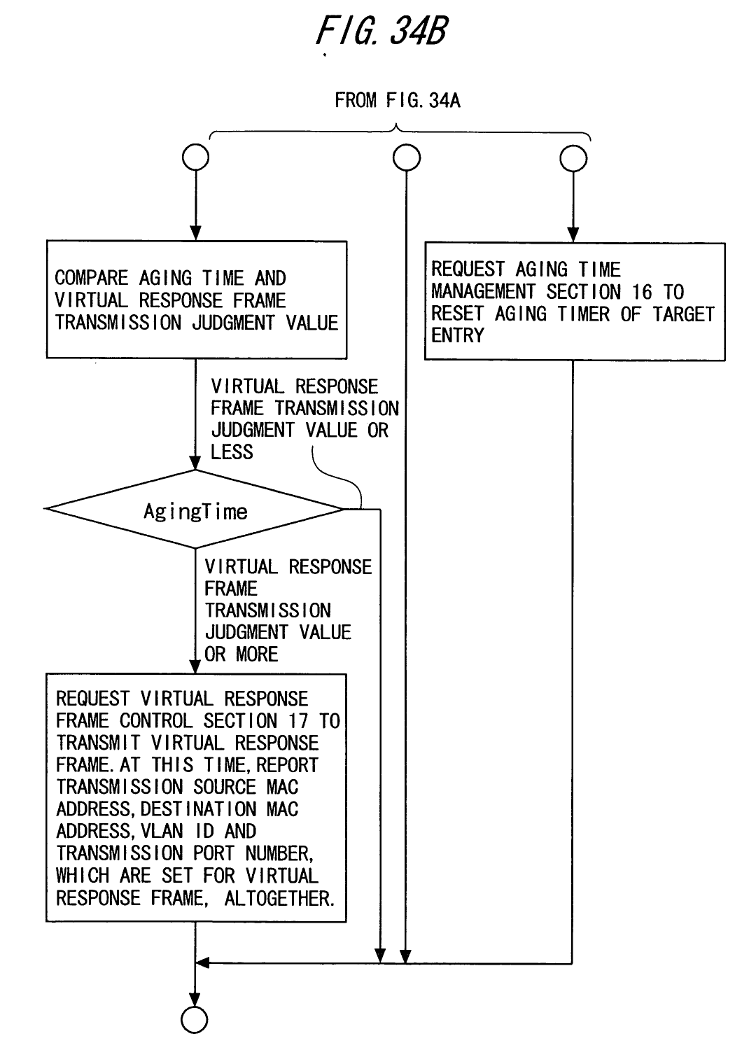

The learning table control section 15 searches the MAC address shown in FIG. 31 in accordance with the transmission source MAC address: 00-E0-00-00-10-20 and the VLAN ID: 1, as illustrated in the process flows of FIG. 34A and FIG. 34B.

The learning table control section 15, since this transmission source MAC address has not been learned, registers the transmission source MAC address: 00-E0-00-00-10-20, the VLAN ID: 1 and the port number: 3, in the MAC address learning table 18. The state of the MAC address learning table 18 at this time is shown in FIG. 32.

Next, the learning table control section 15 searches the MAC address learning table 18 shown in FIG. 32, in accordance with the destination MAC address: 00-E0-00-00-10-20 and the VLAN ID: 1.

The learning table control section 15, since this destination MAC address has already been learned, compares the aging time: 200 s and the virtual response frame transmission judgment value: 240 s. In this case, the aging time is equal to or less than the virtual response frame transmission judgment value, so the learning control section 15 does not request the transmission of the virtual response frame.

The frame transmitted from the port 3 of the L2 switch SW5 is received by the terminal TEA through the L2 switch SW4 corresponding to the destination terminal side switch. The terminal TEA that has received the frame from the terminal TEB transmits the response frame to the terminal TEB. This response frame is received by the L2 switch SW5 through the L2 switch SW4.

The L2 switches SW4, SW5 learn the MAC address: 00-E0-00-00-10-10 of the terminal TEA, the VLAN ID: 1 and the port number: 3, in the MAC address learning table 18 of the L2 switches SW4 and SW5, as shown in FIG. 33.

As mentioned above, in the L2 switch SW2 corresponding to the BCF relay switch, if the aging time is equal to or less than the virtual response frame transmission judgment value, the transmission request of the virtual response frame is not executed. Accordingly, it is possible to instruct the L2 switches SW4 and SW5 to carry out the effective MAC address learning.

### VARIATION EXAMPLE

The processes in the embodiment are provided as the program that can be executed by the computer, and it can be provided through a record medium, such as CD-ROM and a flexible disc, and further through a communication line.

The respective processes can be also executed by selecting and combining any plurality or all of them.

### INDUSTRIAL APPLICABILITY

The present invention can be applied to a network system for providing an L2 switch service or a layer 2 switch as a data transfer apparatus constituting this network system.

What is claimed is:

1. A layer 2 switch, comprising:
a first control unit for, when receiving a frame broadcast-transferred in a layer 2 switch located on a transmission source terminal side, if a destination MAC address included in the frame has already been learned and a transmission source MAC address has not been learned, transmitting a virtual response frame supposing a response frame to be originally transmitted from a destination terminal, from a port that has received the frame; and
a second control unit for discarding the virtual response frame received from a layer 2 switch located on the destination terminal side.

2. A layer 2 switch according to claim 1, wherein, in the virtual response frame, the destination MAC address of the frame is set for the transmission source MAC address, the transmission source MAC address of the frame is set for the destination MAC address, and all “0” data is set for a payload section, respectively.

3. A layer 2 switch according to claim 1, further comprising a third control unit for, if the facts that the destination MAC address included in the frame has already been learned and that the transmission source MAC address has not been learned are detected in accordance with a MAC address learning table, requesting the first control unit to transmit the virtual response frame from the port that has received the frame.

4. A layer 2 switch according to claim 1, further comprising a fourth control unit for, in order to protect a duplicate transmission of the virtual response frame to the layer 2 switch located on the transmission source terminal side, after the transmission of the virtual response frame from the port that has received the frame, monitoring the reception frame for a predetermined time, and if the virtual response frame where both of the destination MAC address and the transmission source MAC address have already been learned is received from the layer 2 switch located on the destination terminal side, discarding the received virtual response frame.

5. A layer 2 switch according to claim 1, further comprising a fifth control unit for determining a transmission necessity or rejection of the virtual response frame, on the basis of an elapsed time of an aging time to delete learning information which is not referred to in a MAC address learning table for a predetermined time.

6. A broadcast suppressing method in a layer 2 switch, comprising:
when receiving a frame broadcast-transferred in a layer 2 switch located on a transmission source terminal side, if a destination MAC address included in the frame has already been learned and a transmission source MAC address has not been learned, transmitting a virtual response frame supposing a response frame to be originally transmitted from a destination terminal, from a port that has received the frame; and
discarding the virtual response frame received from a layer 2 switch located on the destination terminal side.

7. A broadcast suppression method in a layer 2 switch according to claim 6, wherein, in the virtual response frame, the destination MAC address of the frame is set for the transmission source MAC address, the transmission source MAC address of the frame is set for the destination MAC address, and all “0” data is set for a payload section, respectively.

8. A broadcast suppression method in a layer 2 switch according to claim 6, further comprising, if the facts that the destination MAC address included in the frame has already been learned and that the transmission source MAC address has not been learned are detected in accordance with a MAC address learning table, requesting to transmit the virtual response frame from the port that has received the frame.

9. A broadcast suppression method in a layer 2 switch according to claim 6, further comprising, in order to protect a duplicate transmission of the virtual response frame to the layer 2 switch located on the transmission source terminal side, after the transmission of the virtual response frame from the port that has received the frame, monitoring the reception frame for a predetermined time, and if the virtual response frame where both of the destination MAC address and the transmission source MAC address have already been learned is received from the layer 2 switch located on the destination terminal side, discarding the received virtual response frame.

10. A broadcast suppression method in a layer 2 switch according to claim 6, further comprising determining a transmission necessity or rejection of the virtual response frame, on the basis of an elapsed time of an aging time to delete learning information which is not referred to in a MAC address learning table for a predetermined time.
